(19) United States
(12) Patent Application Publication
(10) Pub. No.: US 2025/0057376 A1
(43) Pub. Date: Feb. 20, 2025

(54) APPLIANCE APPARATUS

(71) Applicant: Greenworks (Jiangsu) Co., Ltd, Changzhou (CN)

(72) Inventors: Xi Li, Changzhou (CN); An Yan, Changzhou (CN)

(21) Appl. No.: 18/805,578

(22) Filed: Aug. 15, 2024

(30) Foreign Application Priority Data
Aug. 18, 2023 (CN) 202322236982.1

(51) Int. Cl. A47L 9/28; A47L 7/00; A47L 9/00; B60R 11/00; H02J 7/00

(52) U.S. Cl. CPC A47L 9/2873; A47L 7/0085; A47L 9/0063; B60R 11/00; H02J 7/0044; B60R 2011/0071

(57) ABSTRACT

An appliance apparatus includes a mounting base and a limiting component. The mounting base includes a first mounting slot for detachably mounting a first external device and a second mounting slot for detachably mounting a second external device. The limiting component applies an inward force from an inner side of the first mounting slot to clamp the first external device mounted in the first mounting slot to prevent easy detachment. The first external device charges the second external device when the first external device and the second external device are respectively mounted on the first mounting slot and the second mounting slot.

### CROSS REFERENCE TO RELATED APPLICATIONS

The present application claims the benefit of Chinese Patent Application No. 202322236982.1 filed on Aug. 18, 2023, the contents of which are incorporated herein by reference in their entirety.

### FIELD

The present invention is related to an appliance apparatus, and more particularly related to an appliance apparatus with flexible configuration.

### BACKGROUND

Charging devices efficiently and conveniently is becoming increasingly important in our daily lives. As our reliance on portable tools and appliances grows, especially in situations where access to power outlets is limited, innovative charging solutions become critical. This is particularly true for devices like vacuum cleaners, which have evolved from traditional, corded models to more portable and versatile handheld versions. These cordless vacuum cleaners are favored for their flexibility and ease of use, but they also require thoughtful design in terms of charging to maximize their convenience.

In outdoor environments, where electric sockets may not be readily available, the challenge of keeping devices like vacuum cleaners operational becomes evident. Moving a vacuum cleaner or other tools around in such settings can be cumbersome if the battery life is limited or if recharging requires returning to a fixed location. This is not only inconvenient but also interrupts the workflow, making the task more time-consuming and less efficient.

Gardening tools, much like vacuum cleaners, also face similar challenges. The need for flexible and easily accessible charging options is crucial when working in large outdoor areas, where power sources are sparse. Whether it's a lawnmower, hedge trimmer, or other gardening equipment, the ability to recharge quickly and efficiently without returning to a fixed charging station can significantly enhance the user experience.

To address these challenges, innovative designs that allow for flexible and portable charging solutions are essential. For instance, incorporating charging systems that can be easily stored and accessed without taking up significant space can make a substantial difference. A well-designed mounting structure that accommodates the charger and the tool itself can reduce clutter and make the charging process more seamless.

Moreover, developing charging methods that do not require detaching the battery pack could further enhance convenience. If users can recharge their devices without the need to disassemble components, the overall user experience becomes more intuitive and user-friendly. This kind of innovation can transform the way we interact with our tools, making them more accessible and easier to maintain.

The importance of making charging easier extends beyond just convenience; it plays a crucial role in maximizing the usability of the tools. When charging is straightforward and efficient, users are more likely to keep their devices charged and ready for use, reducing downtime and improving productivity. This is particularly important in settings where time and efficiency are of the essence, such as in professional landscaping or construction work.

The weight of batteries in portable devices is a significant concern, particularly in the design of handheld vacuum cleaners. These batteries, while essential for providing the power needed to operate the devices without being tethered to an electrical outlet, often add considerable bulk and weight. This makes the device more cumbersome to use, particularly during extended cleaning sessions, where the added weight can lead to fatigue and discomfort for the user.

The bulkiness of batteries is not just a minor inconvenience; it directly impacts the usability and overall user experience of the device. When a vacuum cleaner is heavier, it becomes more challenging to maneuver, especially in tight spaces or when cleaning areas above shoulder height. This can make what should be a simple household chore into a more strenuous and time-consuming task, reducing the appeal of what is otherwise a highly convenient tool.

If the issue of battery bulkiness could be addressed, the design of portable vacuum cleaners could see a significant improvement. Lighter batteries would allow for a more streamlined and ergonomic design, making the vacuum cleaner easier to handle and more comfortable to use over longer periods. This would not only improve the user experience but also expand the practical applications of the device, making it suitable for a wider range of users, including those who may currently find these devices too heavy to operate comfortably.

A lighter vacuum cleaner would also mean less strain on the user, which is particularly important for individuals who may have physical limitations or who are required to use the device frequently. For example, older adults or those with conditions that affect their strength and endurance would benefit greatly from a lighter, more manageable device. This could extend the usability of the product to a broader audience, making it a more inclusive tool that caters to a diverse range of needs.

Furthermore, reducing the weight of the battery would also allow for longer usage times without compromising the comfort of the user. A lighter vacuum cleaner could be used for extended cleaning sessions without causing fatigue, making it more efficient for large cleaning tasks or for use in professional settings. This could enhance the productivity of the user, allowing them to complete their tasks more quickly and with less effort.

The potential to design a lighter and more user-friendly vacuum cleaner by solving the problem of battery bulkiness could also lead to innovations in other portable devices. The principles applied to reducing the weight of vacuum cleaner batteries could be extended to other tools and gadgets, leading to a new generation of lightweight, portable devices that are easier and more comfortable to use.

In addition to improving comfort and usability, reducing battery weight could also have a positive impact on the environmental footprint of these devices. Lighter devices require fewer materials to produce and are easier to transport, reducing the energy and resources needed throughout their lifecycle. This aligns with the growing demand for more sustainable and environmentally friendly products.

In conclusion, as we continue to rely on portable and handheld devices for a wide range of tasks, the need for innovative and convenient charging solutions becomes increasingly apparent. By focusing on designs that enhance the flexibility and ease of charging, we can create tools that are not only more convenient to use but also more reliable and effective in various situations. This kind of thoughtful innovation is key to improving the quality of life and making everyday tasks more manageable.

### SUMMARY

In some embodiments, an appliance apparatus includes a mounting base and a limiting component.

The mounting base includes a first mounting slot for detachably mounting a first external device and a second mounting slot for detachably mounting a second external device.

The limiting component applies an inward force from an inner side of the first mounting slot to clamp the first external device mounted in the first mounting slot to prevent easy detachment.

The first external device charges the second external device when the first external device and the second external device are respectively mounted on the first mounting slot and the second mounting slot.

In some embodiments, the first external device is a battery.

The second mounting slot has a second charging electrode for electrically connected to the second external device to charge the second external device with the battery.

In some embodiments, the first mounting slot has a first charging electrode for routing a charging current from the battery to the second external device.

In some embodiments, the appliance apparatus may also include a power cable for connecting to an external power source.

In some embodiments, the power cable is used for guiding a charging current from the external power source to charge the second external device.

In some embodiments, the power cable is also used for charging the first external device via the power cable.

In some embodiments, the mounting base has a rear housing.

The rear housing has a front side and a back side.

The back side of the rear housing is fixed to an installation surface.

The first mounting slot and the second mounting slot are placed on the front side of the rear housing.

In some embodiments, the first mounting slot has a first side wall and a second side wall.

The first side wall, the second side wall and the front side of the rear housing form a recess for inserting the first external device.

In some embodiments, the limiting component includes a connecting rod, a first stop block and a second stop block.

The first stop block and the second stop block are disposed on opposite ends of the connecting rod.

The first stop block and the second stop block are movable in a limited range to clamp the first external device when the first external device is inserted into the first mounting slot.

In some embodiments, the limiting component is disposed to an arched recess of the back side of the rear housing.

In some embodiments, the limiting component has two elastic units for applying elastic force to the first stop block and the second stop block to clamp the first external device.

In some embodiments, the first stop block has multiple locking teeth facing to the second stop block.

There are gaps formed between adjacent locking teeth.

The locking teeth cooperate with the gaps to engage with the first external device mounted in the first mounting slot.

The locking teeth each includes a first portion and a second portion connected in sequence, with the first portion positioned closer to the stop block relative to the second portion.

The end of the second portion, which is farther from the first portion, is inclined toward the first portion to form a guiding slope.

In some embodiments, the connecting rod is provided with an elongated slot parallel to an extending direction of the connecting rod.

The connecting rod is fixed to the rear housing by fasteners that engage with the elongated slot and is slidably connected to the rear housing.

In some embodiments, a manual switch is placed on the front side of the rear housing to selectively activate charging for the first external device to the second external device.

In some embodiments, the second mounting slot has a first locking section for fixing to a second locking section of a bracket body.

The bracket body is mounted to the second mounting slot.

In some embodiments, the bracket body has a support groove for detachably mounting the second external device.

In some embodiments, a second charging electrode is disposed on the support groove to electrically couple to the second external device for charging the second external device.

In some embodiments, the second external device is a portable vacuum cleaner.

In some embodiments, the portable vacuum charges the first external device when the portable vacuum and the first external device are mounted.

In some embodiments, the mounting base is selectively fixed to a vehicle for guiding power to charge the second external device.

### BRIEF DESCRIPTION OF DRAWINGS

FIG. 1 illustrates a mounting base.

FIG. 2 illustrates a portion of the mounting base.

FIG. 3 illustrates a back view of the mounting base.

FIG. 4 illustrates a bracket body example.

FIG. 5 illustrates another view of the bracket body example in FIG. 4.

FIG. 6 illustrates a partial structure of the mounting base.

FIG. 7 illustrates an exploded view of the mounting base.

FIG. 8 illustrates a connecting rod example.

FIG. 9 illustrates a top view when the second external device is mounted.

FIG. 10 illustrates another embodiment.

FIG. 11 illustrates a perspective view of use for the embodiment.

FIG. 12 shows another embodiment.

FIG. 13 shows another view of the example in FIG. 12.

### DETAILED DESCRIPTION

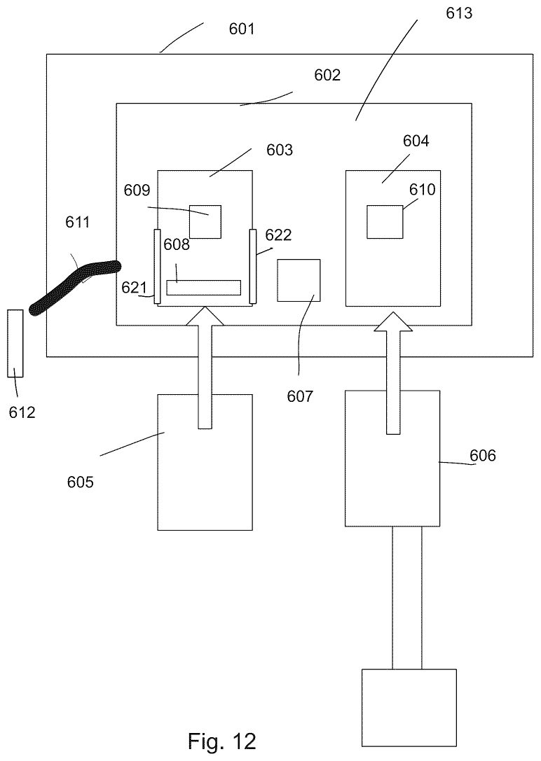

In FIG. 12, an appliance apparatus includes a mounting base 602 and a limiting component 608. The mounting base 602 is to be fixed to an installation platform 601, like a wall surface.

The mounting base 602 includes a first mounting slot 603 for detachably mounting a first external device 605 and a second mounting slot 604 for detachably mounting a second external device 606.

The first external device 605 may be a battery and the second external device 606 may be a portable vacuum machine. The portable vacuum machine may have its own battery, but when its power is not sufficient to continue operation, the portable vacuum machine may be mounted to the second mounting slot 603 to be charged with the battery mounted on the first mounting slot 603.

If the battery in the first mounting slot 603 consumes all its power, users may easily change the battery by detaching from the first mounting slot 603 and replacing with another battery to insert to the first mounting slot 603.

The limiting component 608 applies an inward force from an inner side of the first mounting slot 603 to clamp the first external device 605 mounted in the first mounting slot 603 to prevent easy detachment.

The first external device 605 charges the second external device 606 when the first external device 605 and the second external device 606 are respectively mounted on the first mounting slot 603 and the second mounting slot 604.

In some embodiments, the first external device is a battery.

The second mounting slot 604 has a second charging electrode 610 for electrically connected to the second external device 606, e.g. with a power path disposed in the mounting base to charge the second external device 606 with the battery.

In some embodiments, the first mounting slot 603 has a first charging electrode 609 for routing a charging current from the battery to the second external device.

In some embodiments, the appliance apparatus may also include a power cable 611 for connecting to an external power source 612, e.g. an indoor electric socket connecting to a 110V/220V AC power.

In some embodiments, the power cable 612 is used for guiding a charging current from the external power source to charge the second external device.

In some embodiments, the power cable 612 is also used for charging the first external device via the power cable 612.

In some embodiments, the mounting base has a rear housing 613.

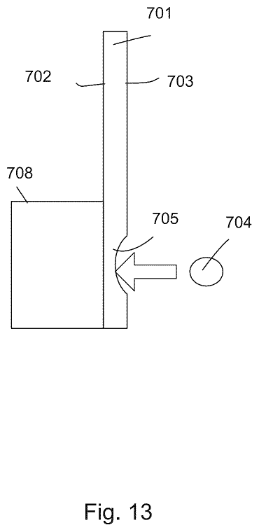

In FIG. 13, the rear housing 701 has a front side 702 and a back side 703.

The back side 703 of the rear housing 701 is fixed to an installation surface, like a wall shown in FIG. 12.

The first mounting slot 708 and the second mounting slot are placed on the front side 702 of the rear housing 701.

In FIG. 12, the first mounting slot has a first side wall 621 and a second side wall 622.

The first side wall 621, the second side wall 622 and the front side of the rear housing 613 form a recess for inserting the first external device 605.

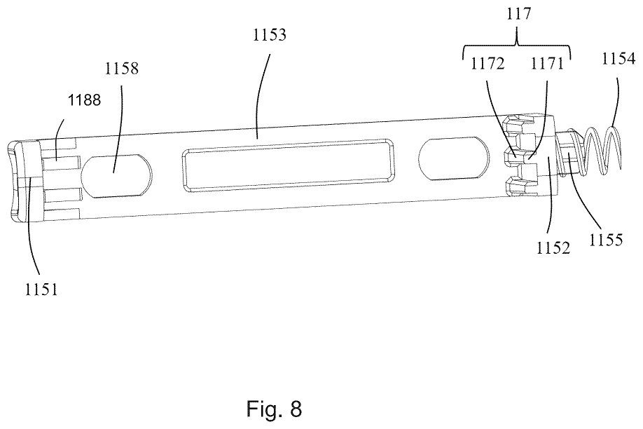

In FIG. 8, the limiting component includes a connecting rod 1153, a first stop block 1151 and a second stop block 1152.

The first stop block 1151 and the second stop block 1152 are disposed on opposite ends of the connecting rod 1153.

The first stop block 1152 and the second stop block 1152 are movable in a limited range limited by a sliding track 1188 to clamp the first external device when the first external device is inserted into the first mounting slot.

In FIG. 13, the limiting component 704 is disposed to an arched recess 705 of the back side 703 of the rear housing 701.

In FIG. 8, the limiting component has two elastic units 1154 for applying elastic force to the first stop block 1152 and the second stop block 1151 to clamp the first external device.

In some embodiments, the first stop block 1152 has multiple locking teeth 117 facing to the second stop block 1151.

There are gaps formed between adjacent locking teeth 117.

The locking teeth cooperate with the gaps to engage with the first external device mounted in the first mounting slot.

The locking teeth 117 each includes a first portion 1171 and a second portion 1172 connected in sequence, with the first portion 1171 positioned closer to the stop block 1152 relative to the second portion 1172.

The end of the second portion 1172, which is farther from the first portion 1171, is inclined toward the first portion to form a guiding slope.

In some embodiments, the connecting rod is provided with an elongated slot 1158 parallel to an extending direction of the connecting rod.

The connecting rod is fixed to the rear housing by fasteners like screws that engage with the elongated slot and is slidably connected to the rear housing.

In FIG. 12, a manual switch 607 is placed on the front side of the rear housing 613 to selectively activate charging for the first external device 605 to the second external device 606.

The manual switch 607 may also select working modes like fast charging or slow charging.

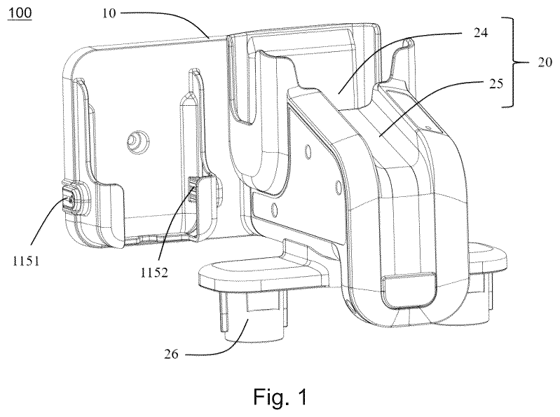

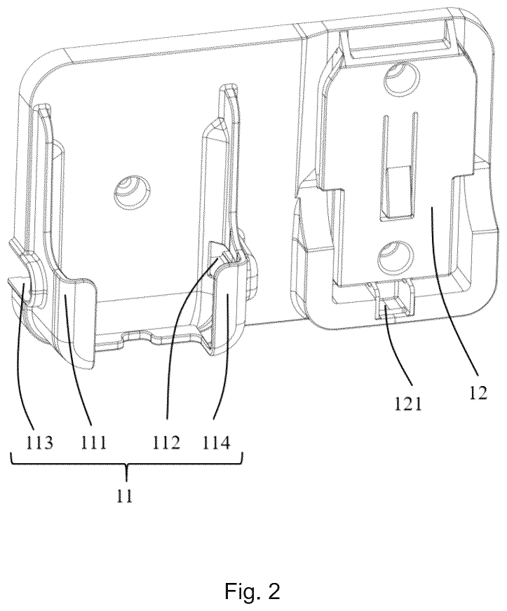

In FIG. 1 and FIG. 2, the second mounting slot has a first locking section 121 for fixing to a second locking section of a bracket body 20.

The bracket body 20 is mounted to the second mounting slot.

In FIG. 1, the bracket body 20 has a support groove 25 for detachably mounting the second external device.

In some embodiments, a second charging electrode is disposed on the support groove 23 to electrically couple to the second external device for charging the second external device.

In some embodiments, the second external device is a portable vacuum cleaner.

In some embodiments, the portable vacuum charges the first external device when the portable vacuum and the first external device are mounted.

In some embodiments, the mounting base is selectively fixed to a vehicle for guiding power to charge the second external device.

The application discloses a mounting base 100, applied in charging devices 200 or charging systems 300. The mounting base 100 of this application can be used to engage external devices 40, external apparatuses, or external chargers 30.

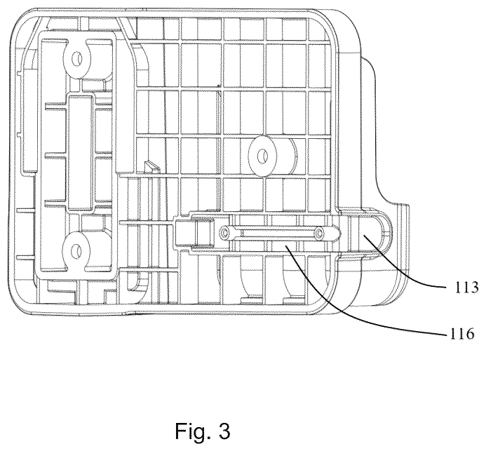

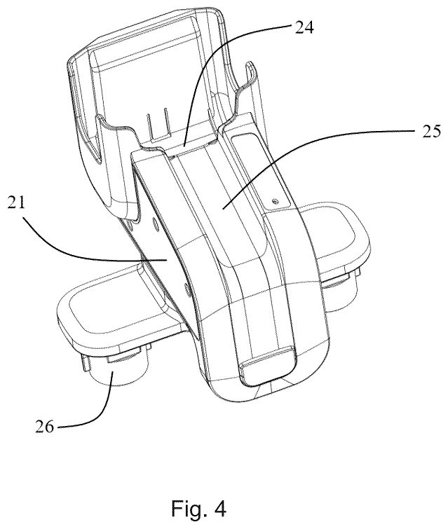

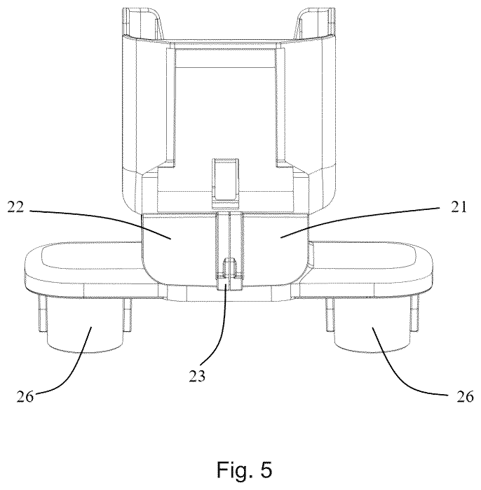

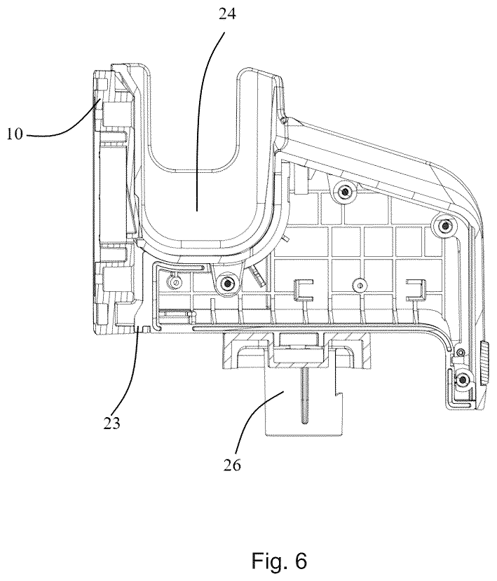

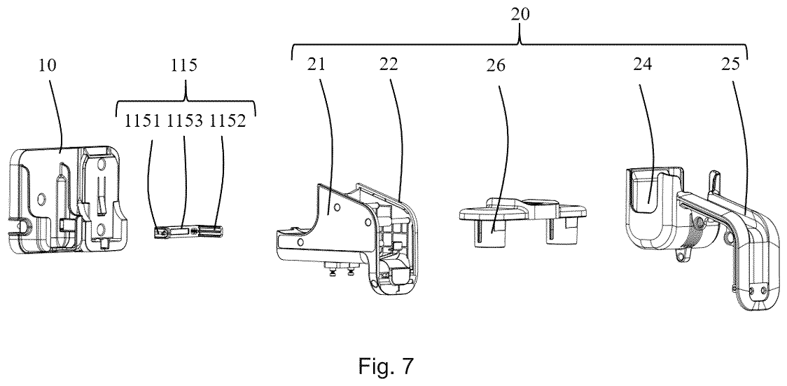

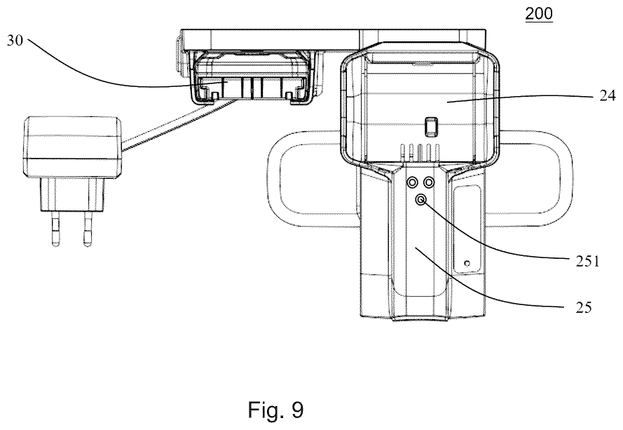

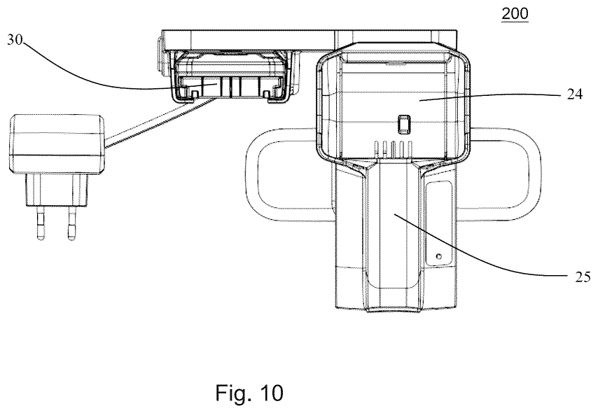

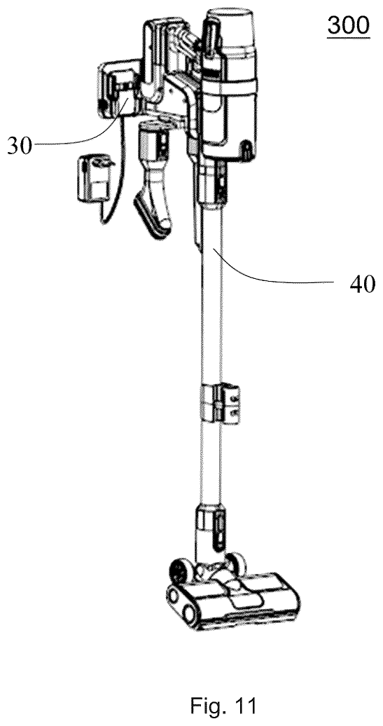

Referring to FIGS. 1 to 11, the mounting base 100 provided by this application includes a rear housing 10 and at least one first mounting slot 11. The rear housing 10 is configured for fixed connection to an installation surface, and the first mounting slot 11 includes a limiting component 115. The limiting component 115 applies an inward force from the side of the first mounting slot 11 to clamp an external device mounted in the first mounting slot 11.

The limiting component 115 in the first mounting slot 11 allows an inward force to be applied to the external device mounted in the first mounting slot 11, thereby stably clamping the external device within it. This design makes it more convenient to insert or remove the external device from the first mounting slot 11, while also keeping the structure relatively simple.

Furthermore, the limiting component 115 includes a connecting rod 1153 and a pressing part 1151 and stop block 1152 located on either side of the connecting rod 1153. One end of the connecting rod 1153, near the stop block 1152, is elastically engaged with the rear housing 10 via an elastic member 1154.

The first mounting slot 11 is equipped with a limiting component 115, configured for detachable connection with an external charger 30. The limiting component 115 includes a connecting rod 1153, as well as a pressing part 1151 and stop block 1152 on either side of the connecting rod 1153. The stop block 1152 is set at a certain angle relative to the connecting rod 1153, with one end of the connecting rod 1153, near the stop block 1152, elastically engaged with the rear housing 10 via an elastic member 1154.

To ensure that the external charger 30 can be more securely inserted into the first mounting slot 11 of the rear housing 10, the first mounting slot 11 is also equipped with a limiting component 115 for clamping the external charger 30. When the external charger 30 is inserted into the first mounting slot 11, it presses against the stop block 1152, which in turn compresses the elastic member 1154 outward, allowing the external charger 30 to be smoothly inserted into the first mounting slot 11. Once the external charger 30 is fully inserted into the first mounting slot 11, the stop block 1152 resets under the force of the elastic member 1154, clamping the external charger 30 securely within the first mounting slot 11. To remove the external charger 30, the pressing part 1151 is first pressed, causing the stop block 1152 to move outward via the connecting rod 1153, thereby allowing the external charger 30 to be easily removed.

The rear housing 10 extends in a direction away from the rear housing, forming oppositely arranged first side wall 111 and second side wall 112. The first side wall 111, rear housing 10, and second side wall 112 together form the first mounting slot 11. The side of the first side wall 111 that faces away from the first mounting slot 11 is provided with a first mounting section 113, while the side of the second side wall 112 that faces the first mounting slot 11 is provided with a second mounting section 114. The pressing part 1151 is movably connected within the first mounting section 113, and the stop block 1152 at least partially passes through the second mounting section 114 to extend into the first mounting slot 11. By positioning the pressing part 1151 and the stop block 1152 of the limiting component 115 within the first mounting section 113 and second mounting section 114, the pressing part 1151 and stop block 1152 are afforded a certain degree of protection, preventing damage due to impacts.

One end of the connecting rod 1153, near the stop block 1152, is provided with an outwardly extending connecting shaft 1155, and the elastic member 1154 is sleeved onto the connecting shaft 1155. The elastic member 1154, which is sleeved onto the connecting shaft 1155, is not easily displaced when subjected to compressive force, resulting in a more stable overall structure.

In some embodiments, the elastic member 1154 is a spring, while in other embodiments, it can be another type of elastic member 1154. The application does not place any limitations on this.

In some embodiments, the stop block 1152 is provided with several locking teeth 117 on the side facing the first mounting slot. Gaps are formed between adjacent locking teeth 117, and the locking teeth 117 cooperate with the gaps to engage with the external charger 30.

The locking teeth 117 include a first portion 1171 and a second portion 1172 connected sequentially. The first portion 1171 is positioned closer to the stop block 1152 compared to the second portion 1172. The end of the second portion 1172, which is farther from the first portion 1171, is inclined towards the first portion 1171 to form a guiding slope. With the guiding slope, when the external charger 30 is inserted into the first mounting slot 11, the locking teeth 117 can be easily pressed outward, allowing the external charger 30 to enter the first mounting slot 11 smoothly, making the locking process more effortless.

The connecting rod 1153 is provided with an elongated slot 1158 that is parallel to the extending direction of the connecting rod 1153. The connecting rod 1153 is fixed to the rear housing 10 through the engagement of a fastener with the elongated slot 1158, while a mounting groove 116 is provided on the rear side of the first mounting slot 11 in the rear housing 10. The connecting rod 1153 is installed in the mounting groove 116, allowing it to be slidably connected to the rear housing 10.

The mounting base 100 also includes a second mounting slot 12, which may have a structure identical to or different from that of the first mounting slot 11.

In some embodiments, when the structure of the second mounting slot 12 differs from that of the first mounting slot 11, the second mounting slot 12 includes a bracket body 20, which comprises a limiting groove 24. The limiting groove 24 is used to engage with the external device 40.

When the external device 40 needs to be placed in the mounting base 100, simply engage one end of the external device 40 with the limiting groove 24 in the bracket body 20 to secure the external device 40. At the same time, insert the external charger 30 used to charge the external device 40 into the first mounting slot 11 of the rear housing 10. This allows the external charger 30 to charge the external device 40 fixed in the bracket body 20, thereby saving space and avoiding the need for frequent replacement of the battery pack in the mounting base 100.

The bracket body 20 includes a support groove 25, which is detachably connected to the limiting groove 24. In some embodiments, a charging slot 251 is provided within the support groove 25, which is used to charge the external device 40. In addition to being able to accommodate the external charger 30 in the mounting base 100, the bracket body 20 is also equipped with an integrated charging slot 251, allowing direct charging of the external device 40 through the charging slot 251. The charging slot 251 can be configured as a fast-charging slot 251, enabling quick charging of the external device 40, thereby enhancing the functionality of the mounting base 100 and meeting various daily usage needs.

In other embodiments, for cost considerations, the charging slot 251 may not be provided within the support groove 25, and the user can charge the external device 40 through the external charger 30 in the first mounting slot 11.

The bottom of the bracket body 20 is equipped with a storage section 26, designed for hanging accessories of the external device 40. External devices 40 are often accompanied by accessories such as cleaning brush heads. Therefore, a storage section 26 is provided at the bottom of the bracket body 20. When the external device 40 is hung on the mounting base 100, the accessories of the external device 40 can be removed and directly hung on the storage section 26, saving space and making reassembly more convenient.

The bottom of the second mounting slot 12 is equipped with a first locking section 121, and the bracket body 20 has a corresponding second locking section 23 at the position corresponding to the first locking section 121. The bracket body 20 is fixed within the second mounting slot 12 through the engagement of the first locking section 121 and the second locking section 23. With this configuration, when installing the bracket body 20 into the second mounting slot 12 of the rear housing 10, it only requires engaging the first locking section 121 with the second locking section 23, making the installation process quicker and the structure more stable.

In some embodiments, the bracket body 20 includes symmetrically arranged first housing 21 and second housing 22, which cooperate to engage with the second mounting slot 12. This split design helps prevent the bracket body 20 from tilting upwards when assembled with the rear housing 10.

In some embodiments, the first locking section 121 is an installation hole, and the second locking section 23 is a protruding insertion part. In other embodiments, the first locking section 121 may be a protruding insertion part, and the second locking section 23 may be an installation hole.

Please continue to refer to FIGS. 1 to 11, which illustrate a preferred embodiment of the charging device 200 of the application.

The charging device 200 includes the mounting base 100 and an external charger 30. The mounting base 100 includes a rear housing 10 and at least one first mounting slot 11. The rear housing 10 is configured for fixed connection to an installation surface, and the first mounting slot 11 includes a limiting component 115. The limiting component 115 applies an inward force from the side of the first mounting slot 11 to clamp the external charger 30 mounted in the first mounting slot 11.

This charging device 200 includes the aforementioned mounting base 100, which includes the rear housing 10 and a bracket body 20 that is assembled with the rear housing 10. The rear housing 10 is fixedly connected to the installation surface and includes the first mounting slot 11 and the second mounting slot 12. The first mounting slot 11 is used for mounting the external charger 30, while the bracket body 20 is fixed to the second mounting slot 12. The bracket body 20 is used to engage the external device 40 and charge the external device 40.

Furthermore, the external charger 30 is lockingly connected within the first mounting slot 11 through the limiting component 115. The limiting component 115 is elastically engaged with the rear housing 10 via an elastic member 1154. It includes a connecting rod 1153, pressing parts 1151 located on both sides of the connecting rod 1153, and stop blocks 1152. The stop blocks 1152 are provided with several locking teeth 117 on the side facing the external charger 30. The external charger 30 has corresponding connection teeth at the position matching the locking teeth 117. When the external charger 30 is inserted into the first mounting slot 11, the locking teeth 117 interlock with the connection teeth and are lockingly connected under the elastic force of the elastic member 1154. When an external force is applied to press the pressing part 1151, the locking teeth 117 move away from the connection teeth, thereby releasing the locking connection.

The application also provides a charging system 300, which includes the charging device 200 and the external device 40. The charging device 200 includes the first mounting slot 11, the second mounting slot 12, and the external charger 30. The external charger 30 is mounted in the first mounting slot 11, and the external device 40 is hung on the second mounting slot 12. The first mounting slot 11 includes a limiting component 115, which applies an inward force from the side of the first mounting slot 11 to clamp the external charger 30 mounted in the first mounting slot 11. The second mounting slot 12 includes a bracket body 20, which is provided with a charging slot 251. The external device 40 is hung on the bracket body 20 and charged through the charging slot 251.

In summary, the mounting base 100 of this application is provided on the rear housing 10 with the first mounting slot 11 and the second mounting slot 12. When the bracket body 20 is used to hang a cleaning device, the user can choose to charge the cleaning device either by using the external charger 30 inserted in the first mounting slot 11 or by using the built-in charging slot 251 in the bracket body 20. The overall installation is convenient and quick, with a stable structure. In daily use, it saves space and eliminates the need for frequent battery pack replacement, thereby enhancing both economic efficiency and practicality.

In addition to vacuum cleaners, the above invention can be used with a variety of other devices, including lawn mowers, hedge trimmers, leaf blowers, and other gardening equipment. It can also be applied to house cleaning machines such as steam cleaners, floor scrubbers, and handheld dusters. Furthermore, this invention is compatible with other power tools like drills, electric saws, and screwdrivers, as well as any portable devices that require frequent charging and easy storage. The versatility of this invention makes it suitable for a wide range of household, gardening, and maintenance equipment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. An appliance apparatus, comprising:
a mounting base, comprising a first mounting slot for detachably mounting a first external device and a second mounting slot for detachably mounting a second external device; and
a limiting component, wherein the limiting component applies an inward force from an inner side of the first mounting slot to clamp the first external device mounted in the first mounting slot to prevent easy detachment;
wherein the first external device charges the second external device when the first external device and the second external device are respectively mounted on the first mounting slot and the second mounting slot.

2. The appliance apparatus of claim 1, wherein the first external device is a battery, wherein the second mounting slot has a second charging electrode for electrically connected to the second external device to charge the second external device with the battery.

3. The appliance apparatus of claim 2, wherein the first mounting slot has a first charging electrode for routing a charging current from the battery to the second external device.

4. The appliance apparatus of claim 1, further comprising a power cable for connecting to an external power source.

5. The appliance apparatus of claim 4, wherein the power cable is used for guiding a charging current from the external power source to charge the second external device.

6. The appliance apparatus of claim 5, wherein the power cable is also used for charging the first external device via the power cable.

7. The appliance apparatus of claim 1, wherein the mounting base has a rear housing, wherein the rear housing has a front side and a back side, wherein the back side of the rear housing is fixed to an installation surface, wherein the first mounting slot and the second mounting slot are placed on the front side of the rear housing.

8. The appliance apparatus of claim 7, wherein the first mounting slot has a first side wall and a second side wall, wherein the first side wall, the second side wall and the front side of the rear housing form a recess for inserting the first external device.

9. The appliance apparatus of claim 8, wherein the limiting component comprises a connecting rod, a first stop block and a second stop block, wherein the first stop block and the second stop block are disposed on opposite ends of the connecting rod, wherein the first stop block and the second stop block are movable in a limited range to clamp the first external device when the first external device is inserted into the first mounting slot.

10. The appliance apparatus of claim 9, wherein the limiting component is disposed to an arched recess of the back side of the rear housing.

11. The appliance apparatus of claim 10, wherein the limiting component has two elastic units for applying elastic force to the first stop block and the second stop block to clamp the first external device.

12. The appliance apparatus of claim 10, wherein the first stop block has multiple locking teeth facing to the second stop block, wherein there are gaps formed between adjacent locking teeth, wherein the locking teeth cooperate with the gaps to engage with the first external device mounted in the first mounting slot; wherein the locking teeth each comprises a first portion and a second portion connected in sequence, with the first portion positioned closer to the stop block relative to the second portion, wherein the end of the second portion, which is farther from the first portion, is inclined toward the first portion to form a guiding slope; wherein the locking teeth each comprises a first portion and a second portion connected in sequence, with the first portion positioned closer to the stop block relative to the second portion, wherein the end of the second portion, which is farther from the first portion, is inclined toward the first portion to form a guiding slope.

13. The appliance apparatus of claim 10, wherein the connecting rod is provided with an elongated slot parallel to an extending direction of the connecting rod, wherein the connecting rod is fixed to the rear housing by fasteners that engage with the elongated slot and is slidably connected to the rear housing.

14. The appliance apparatus of claim 7, wherein a manual switch is placed on the front side of the rear housing to selectively activate charging for the first external device to the second external device.

15. The appliance apparatus of claim 1, wherein the second mounting slot has a first locking section for fixing to a second locking section of a bracket body, wherein the bracket body is mounted to the second mounting slot.

16. The appliance apparatus of claim 15, wherein the bracket body has a support groove for detachably mounting the second external device.

17. The appliance apparatus of claim 16, wherein a second charging electrode is disposed on the support groove to electrically couple to the second external device for charging the second external device.

18. The appliance apparatus of claim 1, wherein the second external device is a portable vacuum cleaner.

19. The appliance apparatus of claim 18, wherein the portable vacuum charges the first external device when the portable vacuum and the first external device are mounted.

20. The appliance apparatus of claim 1, wherein the mounting base is selectively fixed to a vehicle for guiding power to charge the second external device.
